(19) United States
(12) Patent Application Publication
(10) Pub. No.: US 2009/0283550 A1
(43) Pub. Date: Nov. 19, 2009

(54) Extreme Barrier Metal Piston and Container Utilizing Same

(76) Inventor: James F. Kimball, Greenfield, WI (US)

Correspondence Address: S.C. JOHNSON & SON, INC., 1525 HOWE STREET, RACINE, WI, 53403-2236, US

(21) Appl. No.: 12/121,834

(22) Filed: May 16, 2008

(51) Int. Cl. B67D 5/42; G01F 11/00

(52) U.S. Cl. 222/387; 222/389

(57) ABSTRACT

An improved barrier member for use in a pressurized container is disclosed. The barrier member may be manufactured from a sheet metal for improved resistance to product and/or propellant permeation without compromising the sealing performance of the barrier member against the interior surface of the pressurized container. The barrier member may include a flexible sidewall that can conform to the inner sidewall of the container. The disclosed barrier member may also include one or more surface irregularities on the side portion thereof to further improve the sealing performance of the barrier member. The bottom edge of the barrier member may be inwardly curled at one or more peripheral locations to prevent or reduce the scratching of the interior surface of the pressurized container.

### BACKGROUND OF THE DISCLOSURE

1. Technical Field

An improved barrier member for use in a pressurized container is disclosed. The barrier member is preferably manufactured from a sheet metal for improved product/propellant permeation resistance without compromising the sealing performance of the barrier member against the interior surface of the pressurized container. The disclosed barrier member may include one or more surface irregularities on the side portion thereof to further improve the sealing performance of the barrier member. The bottom edge of the barrier member may also be inwardly curled at one or more peripheral locations to prevent or reduce the scratching of the interior surface of the pressurized container by the barrier member.

2. Description of the Related Art

Pressurized dispensing containers which utilize a longitudinally slidable barrier member (or sometimes referred to as “piston”) are known in the art. These pressurized containers are used to dispense a wide range of products. The containers generally include a cylindrical can closed at one end and having a dispensing valve assembly on the other end for controlled discharge of the product contained therein.

The piston is received within the container and serves to separate the container into two chambers. The product to be dispensed typically occupies the upper chamber, above the piston. A pressurized fluid, which acts as a propellant, occupies the lower chamber below the piston. The piston is generally in the form of an inverted cup and has a closed top and an annular skirt or cylindrical sidewall which extends down from the periphery of the closed top. The closed top acts as a barrier wall to separate the product and propellant. The cylindrical sidewall of the piston stabilizes and positions the piston in the container and provides a sliding surface to allow the piston to slide longitudinally within the container.

The product to be dispensed is loaded into the upper chamber of the container under pressure. The loading is typically a three stage operation. During the first stage, known as the filling stage, the product is introduced into the container above the top of the piston. During the second stage, known as the push-down stage, a pressure differential is created above and below the piston to force some of the product down around the periphery of the piston, displacing the air normally present between the piston sidewall and the container, thereby promoting a product seal between the container and the piston. During an optional third stage, known as the push-up stage, the piston is pushed toward the top of the container. This push-up stage eliminates the air in the head space of the container and also causes piston movement that further enables product to be positioned down around the periphery of the piston. After the product is loaded into the upper chamber and the push-down stage is completed, propellant is loaded into the lower chamber under pressure. In use, when the valve at the top of the container is actuated, the propellant pushes the piston toward the top of the container, forcing the product to be dispensed through the valve and actuator.

One common problem associated with the product loading process is the entrapment of air bubbles between the piston sidewall and the interior surface of the container, which may be caused by factors such as the pressure difference between the upper and lower chambers, inadequate venting that would allow trapped air to escape, and/or piston shape that does not properly allow for sufficient product seal formation. It is generally known in the art that the entrapped air bubbles would adversely affect the sealing provided by the product between the piston sidewall and the container. Thus, the sealing performance of the piston would be improved if the piston includes a structural feature that facilitates the venting of the air bubbles during the product loading process.

After the container is loaded, the piston maintains a seal between the piston sidewall and the container surface. The piston also minimizes secondary permeation, which is the diffusion of propellant around the piston and into the product at the propellant-product interface. This secondary permeation allows propellant and product to mix and thus decreases product shelf life and may otherwise adversely affect the product. Further, during the dispensing, with proper design and proper product filling techniques, the sliding piston minimizes the bypass of propellant around the piston sidewall into the product.

A tightly fit piston which provides little clearance between itself and the container inner surface generally decreases secondary permeation. Moreover, increasing the length of the piston sidewall would also decrease secondary permeation. However, a piston which provides little clearance over a longer distance also increases resistance to movement. This increased resistance to movement generally results in increased bypass when the container valve is first opened. Thus, the most effective piston is one which has a diameter capable of minimizing secondary permeation without concomitantly creating a bypass problem within the confines of the piston length necessitated by the pressurized can.

Stepped pistons that do not deform, tilt or shift when the product is loaded into a container at high speed and which facilitate even distribution of product between the piston sidewall and the container are also known in the art. However, in some applications, such as when dispensing liquids and products of low viscosity, or when push-down pressure is too excessive, it is possible for a small portion of the product to pass the piston. The leaking of product past the piston can cause product delivery issues where the claimed label weight cannot be completely delivered because the product leaked through the seal area is not able to be delivered through the valve.

Existing barrier members are generally made from conventional polymers through injection molding or thermoforming processes. Because the relatively low resistance of the polymers against propellant or product permeation, such pistons are suitable for products where product and/or propellant permeation through a piston or migration around a piston would not adversely affect product or container performance. The commonly used polymer materials include, but are not limited to, polyethylene, polypropylene, nylon, acrylonitrile butadiene styrene (ABS), impact modified copolymers of acrylonitrile and methyl acrylate, and laminations or co-extrusions of polypropylene and ethylene vinyl alcohol copolymer (EVOH). Additional attempts to increase barrier have been through chemical alteration such as fluorine treatment of polyolefins. However, existing pistons are still inadequate in preventing permeation of the product or propellant through the pistons that adversely affects the product or container performance, and/or decreases the shelf life of the product. In addition, government regulations are now either enacted or proposed which proactively limit the use of certain propellants, or leakage of same beyond a minimal level. Regulations by the California Air Resource Board (CARB) and the Environmental Protection Agency (EPA) are but two examples.

In light of the above, it can be seen that there is a need for a barrier member for use in a pressurized container with improved permeation resistance against the propellant and/or product. Moreover, there is a need for a barrier member for use in a pressurized container that provides improved sealing performance against the interior surface of the container. Further, there is a need for a barrier member that is durable and economical, complies with governmental standards and improves the shelf life of the pressurized container.

### SUMMARY OF THE DISCLOSURE

This disclosure is generally directed toward a barrier member for use in a pressurized container. The disclosed barrier member may be made of a sheet metal to provide better resistance against propellant and/or product permeation than conventional pistons made of polymeric materials.

In a general embodiment, the disclosed barrier member includes a continuous top portion having a peripheral, a tubular sidewall downwardly extending from the peripheral of the top portion and terminating into a bottom end having a sealing portion that conforms to, but does not completely engage, the interior surface of the pressurized container. The bottom end of the barrier member may be open.

In one embodiment, the barrier member is formed of a thin sheet metal, or a metal/polymer composite such as a laminate thereof. Other non-metal materials with improved propellant and/or product permeation resistance may also be used. The sheet metal, metal/polymer composite, or suitable non-metal material may be sufficiently flexible to facilitate the movement of the barrier member when the container is pressurized so that the sealing portion of the barrier member bottom end conforms to the interior surface of the container for improved sealing performance throughout the length of the container.

As the product is dispensed from the container, the barrier member rises toward the top of the container. In order to achieve maximum product dispensing, the top portion of the barrier member may have a contoured profile that conforms to the top interior surface of the pressurized container so that product retention can be minimized. In one embodiment, the top portion of the barrier member may include an annular wall rising from the vicinity of the top portion's periphery to form a stepped structure. The center of the continuous top portion may be recessed below the rim of the annular wall.

The bottom end of the barrier member may include a flange radially protruding from the bottom of the sidewall and terminating into a bottom edge. In one embodiment, the sidewall and/or bottom end of the barrier member may include one or more surface irregularities or disruptions for improving the sealing performance of the barrier member.

In a refinement, the surface irregularity may be provided by contouring the bottom edge of the disclosed barrier member into various profiles, such as sinusoidal, scalloped, castellated, etc. The contoured bottom edge does not significantly affect the outer circumference of the piston.

In another refinement, the surface irregularity may be provided as one or more transverse openings through the sidewall or bottom end of the barrier member. The vents may be mechanically created, laser-induced, or chemically etched.

In yet another refinement, the surface irregularity is provided as one or more surface depressions on the bottom end of the disclosed barrier member.

The bottom edge of the barrier member may further include an inwardly directed curl at one or more locations in order to reduce scratching or scraping of the interior surface of the pressurized container, which sometimes is covered with a coating to protect against corrosion. Furthermore, the side portion of the disclosed barrier member may include a plurality of recesses to further increase the flexibility of the barrier member, thereby enabling the barrier member to conform to minor irregularities of the interior surface of the pressurized container.

The disclosed barrier member may also include surface coatings to enhance its corrosion resistance. Suitable coatings include organic coatings and metal/plastic laminates generally used in aerosol device manufacturing.

The disclosed barrier member also retains desirable features of existing pistons or barrier members such as proper dimension and thickness to prevent tipping of the piston and/or leaking of the product therethrough.

Any of the aforementioned features could be formed at the same time the barrier member is formed, or alternatively, introduced in a secondary operation. Other advantages and features will be apparent from the following detailed description when read in conjunction with the attached drawings. It will also be noted here and elsewhere that the barrier member disclosed herein may be suitably modified to be used in a wide variety of pressurized or non-pressurized containers by one of ordinary skill in the art without undue experimentation.

### BRIEF DESCRIPTION OF THE DRAWINGS

For a more complete understanding of the disclosed barrier member, reference should be made to the embodiments illustrated in greater detail in the accompanying drawings, wherein:

FIG. 1 is a side sectional view of one embodiment of the disclosed barrier member in a conventional pressurized container constructed in accordance with this disclosure;

FIG. 2 is an enlarged sectional view of the barrier member shown in FIG. 1;

FIG. 3 is a further enlarged sectional view of the barrier member shown in FIGS. 1 and 2, particularly illustrating a stepped transition on the side portion of the barrier member of one embodiment of the disclosure;

FIG. 4A is side plan view of one embodiment of the disclosed barrier member, particularly illustrating the grooves on the side portion of the barrier member for increasing the flexibility of same;

FIG. 4B is a bottom view of the barrier member shown in FIG. 4A;

FIG. 5A is a side plan view of one embodiment of the disclosed barrier member, particularly illustrating the scalloped profile on the bottom edge of the flange;

FIG. 5B is a side plan view of another embodiment of the disclosed barrier member, particularly illustrating the castellated profile on the bottom edge of the flange;

FIG. 5C is a side plan view of another embodiment of the disclosed barrier member, particularly illustrating the downwardly extending nibs on the bottom edge of the flange;

FIG. 6A is a partial sectional view of a prior art piston/can interface, showing how scratching or scraping can occur;

FIG. 6B is a partial sectional view of one embodiment of the disclosed barrier member, particularly illustrating the inward curl provided on the bottom edge of the barrier member;

FIG. 6C is a bottom view of the barrier member shown in FIG. 6A, particularly illustrating the location of the inward curls;

FIG. 7A is a side plan view of one embodiment of the disclosed barrier member, particularly illustrating the transverse slits on the side portion of the barrier member;

FIG. 7B is an enlarged fragmentary view of a portion of the piston showing the transverse slit in greater detail;

FIG. 7C is a side sectional view of the barrier member shown in FIG. 7B take along line 7C-7C, particularly illustrating formation of the slits and the stepped transition on the sidewall to the flange;

FIG. 7D is another side sectional view similar to FIG. 7C, but without bent surfaces adjacent the slit;

FIG. 8 is a partial side plan view of one embodiment of the disclosed barrier member, particularly illustrating some possible shapes and locations of the transverse vents on the side portion of the barrier member;

FIG. 9A is a side plan view of one embodiment of the disclosed barrier member, particularly illustrating depressions on the flange of the barrier member; and

FIG. 9B is a bottom view of the barrier member shown in FIG. 9A, particularly illustrating the location of the depressions on the flange.

It should be understood that the drawings are not necessarily to scale and that the disclosed embodiments are sometimes illustrated diagrammatically and in partial views. In certain instances, details which are not necessary for an understanding of the disclosed barrier member or which render other details difficult to perceive may have been omitted. It should also be understood, of course, that this disclosure is not limited to the particular embodiments illustrated herein, but rather it is the intention of this disclosure to also cover all modifications, alternative constructions, and equivalents of the disclosed embodiments as well.

### DETAILED DESCRIPTION OF THE DISCLOSURE

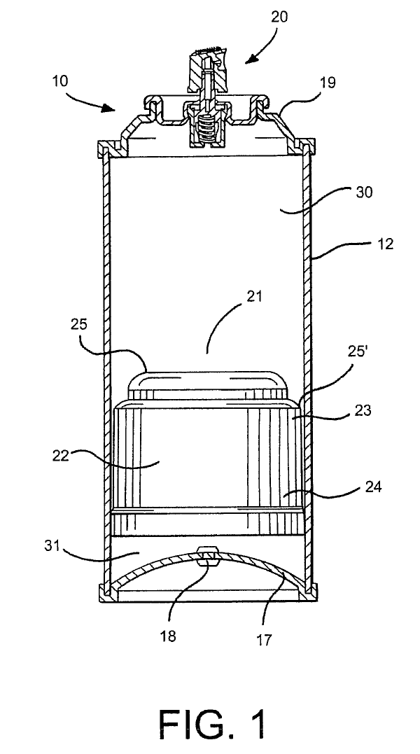

Referring now to the drawings, and with specific reference to FIG. 1, a conventional pressurized container is generally referred to as reference numeral 10. While the container 10 may be an aerosol container, and have the type of nozzle depicted, or be crimped and sealed with a grommet as depicted, it is to be understood that these are but examples of the types of containers in which the extreme barrier piston of the present disclosure can be employed. Again with reference to container 10, it is shown to include a cylindrical wall 12 formed of a flat piece of sheet metal. Attached to the bottom edge of the sidewall 12 is a bottom wall 17 having a center charging orifice, through which a pressurized fluid is charged into the container 10. The charging orifice is closed by a resilient plug 18 after the pressurized fluid is charged. Attached to the top edge of the side wall 12 is a top wall 19 having a large center opening, through which a valve assembly 20 is inserted. The edge of the valve assembly 20 is crimped to the edge surrounding the opening in the top wall 19 to seal the pressurized container. The container 10 may be one-piece or multiple-piece, metal or plastic, straight wall or necked. The container 10 may also have a cross sectional profile of an oval or any other shapes known in the art. It is to be understood that this disclosure is not limited to the pressurized container described herein. Other pressurized containers of various shapes, methods of construction, structures and materials may also be used with the disclosed barrier member by one of ordinary skill in the art.

As illustrated in FIG. 1, a hollow barrier member or piston 21 is slidably disposed in the container 10 for longitudinal movement therein. The barrier member 21 divides the interior of the container 10 into an upper chamber 30 and a lower chamber 31. In use, the upper chamber 30 above the piston 21 is filled with the product to be dispensed, and the lower chamber 30 below the piston 21 is filled with a propellant. The products may include, but are not limited to, shave gels, lotions, caulking compositions, medications, food products, automotive products, cleaning compositions, deodorants, disinfectants, or any other product known in the art that are suitable for use in a pressurized container equipped with a barrier member. The propellants, on the other hand, may include liquid petroleum gas, compressed air, or other suitable pressurized fluids.

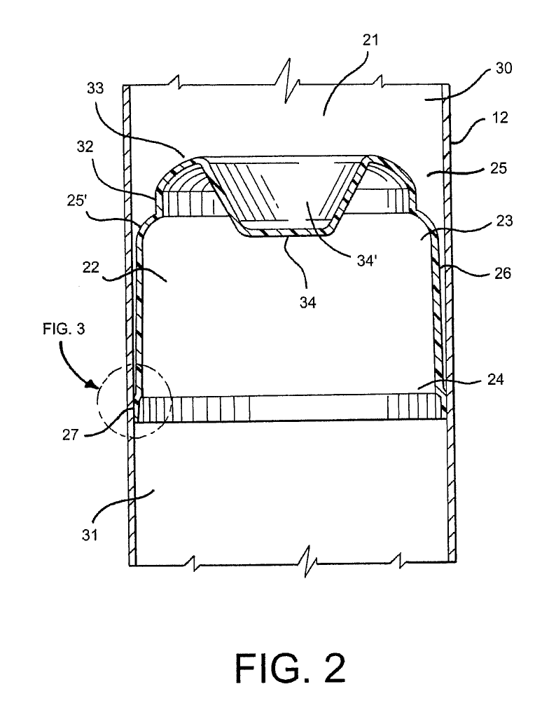

In a general embodiment illustrated in FIGS. 1 and 2, the barrier member 21 includes a tubular side portion 22 having a top end 23 and a bottom end 24. The top end 23 of the side portion 22 is closed by a continuous top portion 25 having a periphery 25′. The bottom end 24 of the side portion 22 may be open. The side portion 22 includes a tubular sidewall 26 extending between the top and bottom ends (23, 24). In a preferred embodiment, the exterior surface of the sidewall 26 is substantially cylindrical and closely conforms to, but does not completely engage, the interior cylindrical surface of the container 10. In another embodiment, the sidewall 26 has a steep frusto-conical shape. Other geometric shapes appropriate for the sidewall 26 will be apparent to those of ordinary skill in the art and should not be considered as limiting the scope of this disclosure.

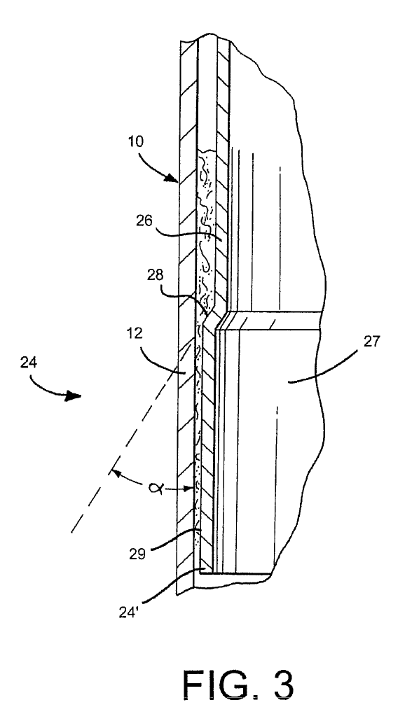

In order to form a product seal between the barrier member 21 and the container 10, the bottom end 24 of the tubular side portion 22 may include a sealing portion that conforms to, but does not completely engage, the interior surface of the container 10. In an embodiment illustrated in FIG. 3, the bottom end 24 of the tubular side portion 22 may include a flange 27. The flange 27 includes a top edge 28 radially extending from the bottom of the sidewall 26 to form a slightly stepped transition. In another embodiment (not shown), the top edge 28 of the flange 27 is merged with the bottom of the sidewall 26, thereby forming a continuous transition. The flange 27 further includes a sealing wall 29 downwardly extending from the top edge 28 and terminating into the bottom edge 24′ of the side portion 22. The sealing wall 29 and the bottom edge 24′ may conform to, but not completely engage, the interior surface of the container 10. The sidewall 26 and the flange 27 may be sufficiently flexible so that when the container 10 is pressurized with the propellant, the side portion 22 of the disclosed barrier member 21 moves to conform to any irregularity or disruption on the interior surface of the container 10 to provide a better seal against the container 10.

It is noteworthy that the inclusion of the flange 27 is optional and should not be considered as limiting the scope of this disclosure. For example, instead of the flange 27, the bottom end 24 of the tubular side portion 22 may include one or more fins, ribs, rings of a wide variety of shapes and configurations (not shown) known in the art as long as those shapes and configurations provide a sealing portion that conforms to the interior surface of the container 10. In yet another embodiment, the bottom end 24 is simply the bottom edge 24′ of the barrier member, into which the sidewall 26 terminates (not shown).

Referring back to FIG. 1, as the product is dispensed out of the container 10 by the propellant, the barrier member 21 rises toward the top of the container 10. In order to minimize product retention, the top portion 25 is shaped to generally conform to the shape of the lower surface of the top wall 19 and the valve assembly 20 so that when the barrier member 21 reaches the top of the container 10 it will expel all or substantially all of the product in the container through the valve assembly 20. Although it is preferable that the top portion 25 conforms to the lower surface of the top wall 19, the shape of the top portion 25 should not be considered as limiting the scope of this disclosure. One of ordinary skill in the art should recognize that the top portion 25 may be flat, curved, or irregularly shaped without substantially affecting the operability of the disclosed barrier member 21.

FIGS. 2 and 3 graphically illustrate another embodiment of the disclosed barrier member used in a conventional pressurized container 10. In this embodiment, the top portion 25 of the barrier member 21 includes an annular top wall 32 rising upwardly from the vicinity of the periphery 25′ and terminating into a top rim 33, which in turn, is connected to a circular plate 34 positioned below the top rim 33 to form a central recess region 34′. As the barrier member 21 rises to the top of the container 10, the bottom portion of the valve assembly 20 is supported by the central recess region 34′ of the top portion 25, while the annular top wall 32 and top rim 33 of the top portion 25 is reciprocally accommodated by the top wall 19 of the container 10. As a result, the top portion 25 of the barrier member 21 conforms closely to the lower surface of the top of the container 10, thereby minimizing product retention.

The materials from which the disclosed barrier member can be manufactured are varied and include, but are not limited to, sheet metals conventionally used in high speed metal forming processes such as those used in food or beverage can manufacturing. In one embodiment, the disclosed barrier member 21 is manufactured from steel or aluminum sheet. The steel may be tin-free or tin-plated depending on application of the barrier member. The metal sheet that forms the disclosed barrier member may be sufficiently flexible so that at least the side portion 22 of the barrier member 21 can conform to the interior surface of the container 10 when pressure is applied.

In one embodiment, the barrier member is manufactured by conventional methods used to form two-piece cans. In another embodiment, the barrier member is manufactured by using progressive dies to shape a flat metal sheet into a metal member of a desired form through progressive tooling of two or more steps. This method is also used in aerosol valve cup manufacture, aerosol end formation, and decorative metal closure manufacture.

In order to improve the permeation resistance against propellants such as liquefied petroleum gases or compressed gases, the conventional plastic barrier member may be treated with one of many surface modification methods including, but are not limited to, fluorine gas treatment, coatings such as polyvinylidene chloride, vapor-phase metal deposition, incorporation of a barrier plastic, etc. As the disclosed barrier member is directly formed of a metal sheet, it provides better permeation resistance against aerosol propellants than that of the conventional pistons, such as pistons substantially made of polymeric material or modifications thereof known in the art. Permeability data of pistons made of polymeric materials and metal sheet against two known propellants (N₂ and CO₂) are listed in the table below. The permeability is measured in cm³·mm/(m²·day) by methods known in the art. In one embodiment, the permeation resistance of the disclosed barrier member against nitrogen is less than 0.0015 cm3·mm/(m2·day). In another embodiment, the permeation resistance of the disclosed barrier member against carbon dioxide being less than 0.01 cm3·mm/(m2·day).

| Piston Material | Permeability (N₂) | Permeability (CO₂) |
|---|---|---|
| EVOH | 0.0015-0.003 | 0.01-0.08 |
| Nylon 6 | 0.35 | 3 |
| Nylon 66 | 0.3 | 3 |
| Nylon | 0.5 | 3 |
| Polycarbonate | 13 | 500 |
| PET | 0.3 | 6 |
| HDPE | 20 | 200 |
| LDPE | 60 | 700 |
| EVA | N/A | 1100 |
| OPP | 17 | 200 |
| PS | 20 | 400 |
| UPVC | 7 | 15 |
| PPVC | 70 | 900 |
| PVDC | 0.1 | 2 |
| PVA | N/A | 0.04 |
| Polyimide | N/A | 60 |
| Metal Sheet | <0.0015 | <0.01 |

The barrier member 21 may also include a surface coating to enhance its corrosion resistance during storage or during normal shelf and usage when the barrier member is exposed to the products or propellants. The coatings may be organic coatings and metallic/plastic laminates used in aerosol cans and aerosol valves, or any other anti-corrosive coatings known in the art. The organic coatings include, but are not limited to, organosols, epoxides, polyamideimide compounds, etc. The metallic/plastic coatings may be laminates of polypropylene (or polyethylene or polyester) and steel, such combinations similar to those commonly used in the manufacture of aerosol valves, aerosol ends, and some aerosol can bodies.

The disclosed barrier member may also retain desirable dimension and thickness of existing pistons or barrier members to prevent tipping of the piston and/or leaking of the product therethrough. For example, one of ordinary skill in the art would be able to properly select the diameter of the bottom end 24 and the height of the sidewall 26 to stabilize the barrier member 21 as it slides longitudinally within the container 10.

The barrier member 21 may have a substantially uniform thickness throughout its structure. In one embodiment, the thickness of the metal sheet is 0.006 inch. Another feature that may improve the stability and sealing performance of the barrier member is the angle at which the annular bottom flange is merged with the sidewall 26, shown in FIG. 3 as α. In one embodiment, α ranges from about 5 to about 90 degrees. In another embodiment, α is about 12 degrees.

As discussed above, the product sandwiched between the side portion 22 of the barrier member 21 and the interior surface of the container 10 provides an effective seal so that no significant amount of product is leaked into the lower chamber 31. In one embodiment, the exterior surface of the sidewall 26 is smooth and continuous, and has a generally circular cross-section with a slight constant outward taper toward the annular bottom flange 27. This tapered sidewall 26 allows a small amount of the product in the upper chamber 30 of the container 10 to fill in the space between the interior surface of the container 10 and the barrier member 21, thereby providing sufficient sealing and lubrication to facilitate the longitudinal sliding movement of the barrier member 21.

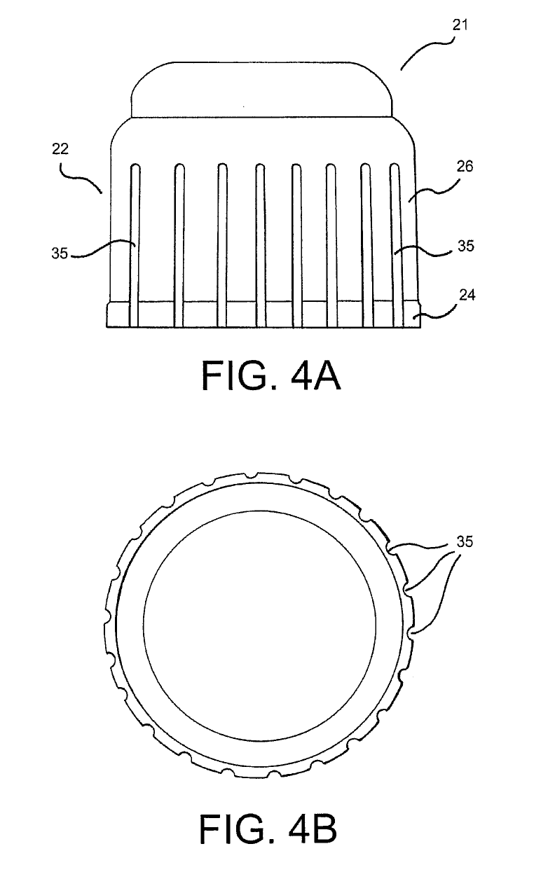

To further increase the flexibility of the side portion 22 so that the side portion can, under pressure, conform to irregularities or disruption on the interior surface of the container 10, a plurality of recesses 35 may be provided intermittently on the exterior surface of the sidewall 26 and/or the bottom end 24 as illustrated in FIGS. 4A and 4B. The recesses 35 may be universally sized with identical length, width and depth. The recesses 35 may also be evenly spaced apart and be in substantially parallel relationship with one another. In one embodiment, the recesses 35 are vertical and extend substantially throughout the vertical length of the side portion 22. However, the recesses 35 may also be of other lengths or positioned at other orientations that are obvious to one of ordinary skill in the art.

As shown in FIG. 4B, the recesses 35 are evenly distributed on the circumference of the sidewall 26 or bottom end 24, thereby creating a plurality of weakened regions on the side portion 22 of the barrier member 21. In such embodiment, the depth of the recesses 35 preferably does not exceed 50% of the thickness of the sidewall 26 and bottom end 24 in order to maintain the mechanical strength and structural rigidity of the barrier member 21. However, deeper recesses may be provided on the barrier member 21 if the material of the barrier member allows the weakened regions to maintain its integrity under the pressure within the container 10. The recesses 35 may have a wide variety of shapes and widths. In one embodiment, the cross-sectional profile of the grooves is an arc. Other cross-sectional profiles that are obvious to one of ordinary skill in the art, such as V-shaped or rectangular shaped, may also be used when forming the recesses 35 and should not be considered as limiting the scope of this disclosure.

The recesses 35 may be formed on the side portion 22 of the barrier member 21 by any method known in the art. Suitable methods include, but are not limited to, laser etching, chemical etching, mechanical machining, mechanical forming, etc. The recesses 35 may be formed on a flat sheet metal before the sheet metal is processed into the barrier member, or they may be formed after the barrier member takes shape in a separate process. It is to be understood that one of ordinary skill in the art would be able to select the proper method to form the recesses without undue experimentation.

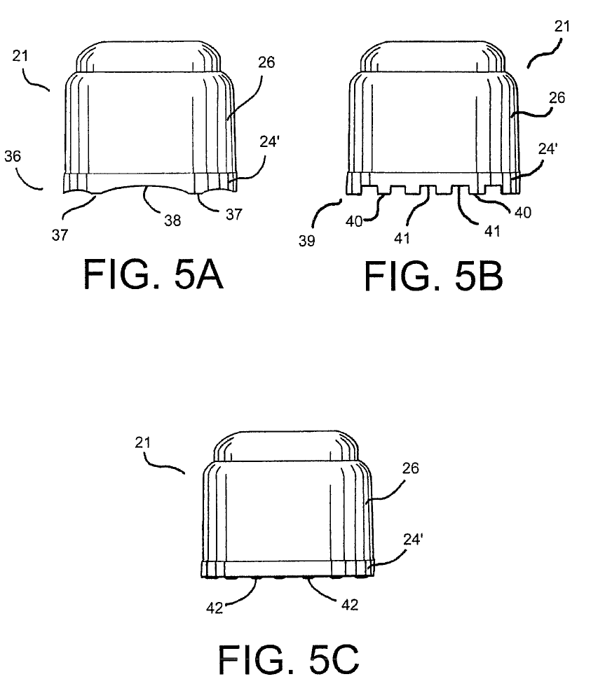

To further enhance the sealing between the barrier member 21 and the interior surface of the container 10, the barrier member 21 may include one or more surface irregularities on the sidewall 26 and/or bottom end 24 of the barrier member 21. For example, the surface irregularity may be formed by contouring the open bottom edge 24′ of the barrier member 21 without substantially affecting the outer circumference of the bottom edge 24′. As illustrated in FIGS. 5A-C, the bottom edge 24′ of the barrier member 21 may be contoured into a plurality of shapes including, but are not limited to, sinusoidal, castellated, scalloped, or otherwise intermittently modified shapes to provide proper positioning of the barrier member, adequate side profile, as well as improved venting of the air during the product sealing process.

As illustrated in FIG. 5A, the bottom edge 24′ of the barrier member 21 may have a scalloped contour 36 that includes two or more contact points 37 and arcs 38 formed therebetween. In one embodiment, the scalloped contour 36 includes four or five contact points 37 evenly distributed on the circumference of the bottom edge 24′. In another embodiment, each contact point 37 includes a flat distal end of 0.100″ width. Each arc 38 extends between two adjacent contact points 37 and has a height of about 0.040″ to 0.050″. Of course, the distal end of the contact point 37 may also be pointed, slanted or of any other applicable shape apparent to one of ordinary skill in the art. Similarly, the arc 38 may be of any height appropriate for the manufacturing and application of the barrier member. It is to be understood that disclosed barrier member should not be limited to the number, size and shape of the tips or the height of the arc.

In another embodiment illustrated in FIG. 5B, the bottom edge 24′ of the barrier member 21 has a castellated contoured profile 39 which includes a plurality of alternating projections 40 and recesses 41 evenly distributed throughout the circumference of the bottom edge 24′. The projections 40 or recesses 41 may be of the same shape and size, such as rectangular, square, triangular, arc, half-moon, etc. The castellated contour profile 39 may include three or more projections 40. In one embodiment, seven projections 40 can be provided, but it is to be understood that the shape, height and width of the projections 40 and recesses 41 are not meant to limit the scope of this disclosure and that one of ordinary art would be able to modify the castellated contoured profile 39 illustrated in FIG. 5B into other appropriate shapes and profiles without undue experimentation.

Besides the scalloped and castellated profiles (36, 39) discussed above, there are many other shapes and profiles that can be applied to the bottom edge 24′ of the barrier member 21 as the surface irregularity. For example, the bottom edge 24′ may include one or more downwardly extending nibs 42, as illustrated in FIG. 5C. Other appropriate shapes and configurations of the contoured profile would be apparent to one of ordinary skill in the art and should not be considered as limiting the scope of this disclosure.

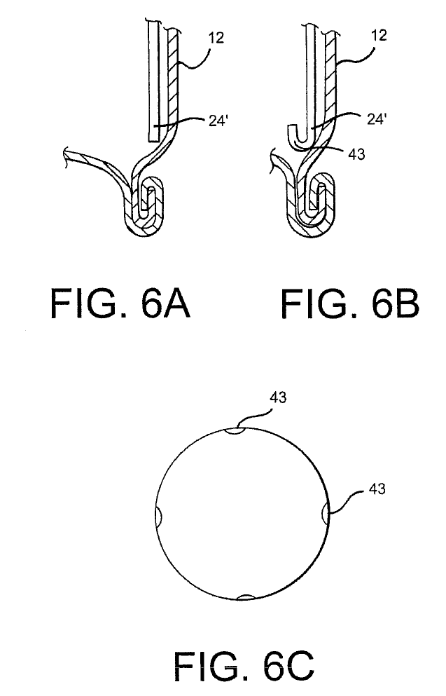

Because the container 10 sometimes includes an interior surface coating, it is sometimes desirable to prevent or reduce the scratching or scraping of the interior surface of container by the longitudinal sliding movement of the disclosed barrier member 21. Thus, when the bottom edge 24′ of the barrier member 21 is contoured to include one or more contact points/projections/nibs, at least one of the contact points/projections/nibs may be provided with a distal inward curl or deflection 43. The inward curl 43 may also be provided to a non-contoured bottom edge 24′. As illustrated in FIG. 6B, the inward curl or deflection 43 provides significantly smoother contact between the barrier member 21 and the interior surface of the container 10 than straight distal end designs, thereby reducing coating damages at the necked-in area of container sidewall 12 as shown in FIG. 6A.

In an embodiment illustrated in FIG. 6C, four inward curls 43 are evenly distributed on the circumference of the bottom edge 24′ of the barrier member 21. However, the number of the curls can range from one to the total number of the contact points/projections/nibs. In a barrier member with a non-contoured bottom edge (not shown), the inward curl may be provides at selected sections, or on the entirety, of the bottom edge 24′. It is to be understood that the number and location of the inward curls are not meant to limit the scope of this disclosure.

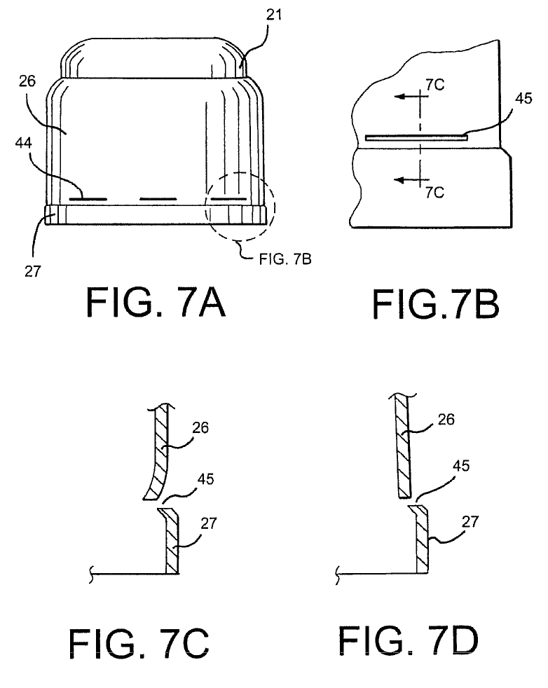

The surface irregularity may also be provided as one or more transverse vents 44 on the side portion 22 of the barrier member 21. In one embodiment illustrated in FIGS. 7A and 7B, the transverse vents 44 are in the form of narrow slits 45 provided on the sidewall 26 of the barrier member 21. In one embodiment, the slits 45 are positioned in the vicinity of where the top edge of the flange 27 merges with the bottom of the sidewall 26. The slits 45 may be formed as a discontinuity between the bottom of the sidewall 26 and the top edge of the flange 27. In another embodiment illustrated in FIG. 7C, the bottom of the sidewall 26 is inwardly deflected so as to create the discontinuity as well as the stepped transition from the sidewall 26 to the flange 27. In another embodiment illustrated in FIG. 7D, the sidewall 26 and the flange 27 are misaligned with each other, thereby forming the slits 45 as well as the stepped transition.

In another refinement, each of the slits 45 has a length of about 0.200″ and a width of from about 0.003″ to about 0.005″. As illustrated in FIG. 7A, the slits 45 may be horizontally oriented in an inline configuration. However, the slits 45 may also be vertical or slanted, located on the sidewall of annular wall, and oriented in a parallel or random configuration. It is to be understood, of course, that the appropriate size, location, and orientation of the slits 45 would be apparent to one of ordinary skill in the art and should not be considered as limiting the scope of this disclosure.

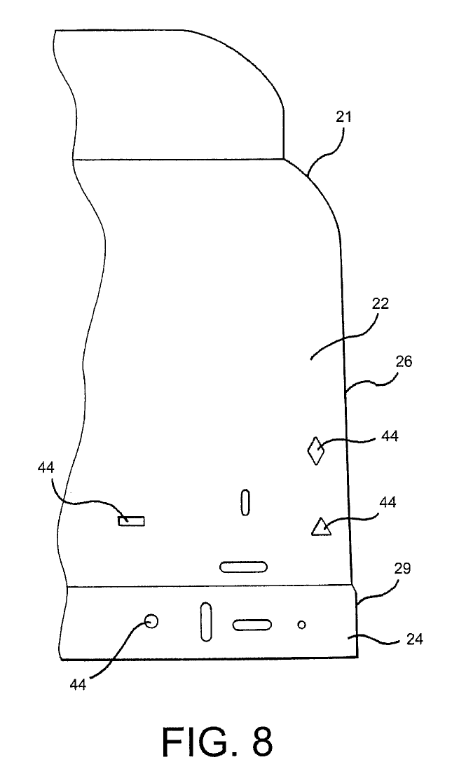

As illustrated in FIG. 8, the transverse vents 44 may also be of other shapes including, but are not limited to, circles, ovals, elongated ovals, triangles, diamonds, squares, rectangles, or other shapes known in the art. The transverse vents 44 can be located either on the lower portion of the sidewall 26, or on bottom end 24, or both. In addition, the transverse vents 44 can be oriented inline, parallel to each other, in a random configuration or other configurations known in the art. In light of this disclosure, one of ordinary skill in the art should be able to modify the shape, size, location and orientation of the transverse vents 44 without undue experimentation.

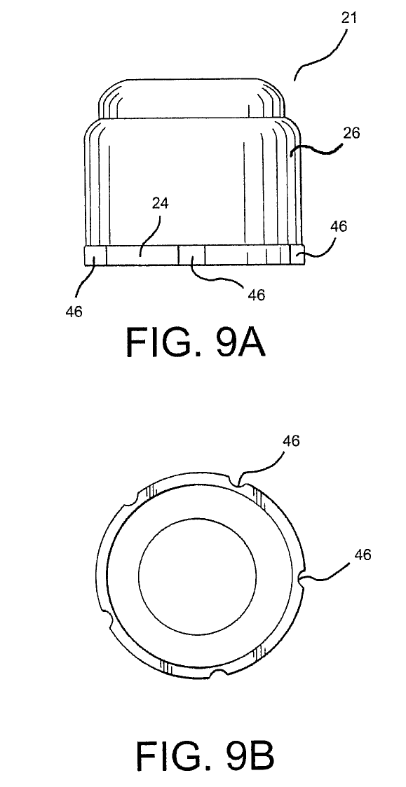

Finally, the surface irregularity of the disclosed barrier member may be one or more depressions 46 provided on the bottom end 24 of the barrier member 21. In an embodiment illustrated in FIG. 9A, the depressions 46 are longitudinally oriented on the bottom end 24. In a further refinement, the depressions 46 are vertical and each has a length of about 0.200″ to about 0.300″ and a depth of about 0.010″ to about 0.020″. However, one of ordinary skill in the art should understand that the depressions 46 can also have a slanted or random orientation on the bottom end 24.

As illustrated in FIG. 9B, the depressions 46 may be evenly distributed on the circumference of the annular bottom flange 27. In a refinement, the flange 27 may include more than two, or more than four, depressions 46. In FIG. 9B, five vertical depressions 46 are evenly distributed along the circumference of the flange 27. It is to be understood that the size, orientation, and location of the depressions 46 applicable to the disclosed barrier member would be apparent to one of ordinary skill in the art and should not be considered as limiting the scope of this disclosure.

The transverse vents 44 and the depressions 46 discussed above may be formed on the side portion 22 of the barrier member 21 by any method known in the art. Suitable methods include, but are not limited to, laser etching, chemical etching, mechanical machining, mechanical forming, etc. The transverse vents 44 and the depressions 46 may be formed on a flat sheet metal before the sheet metal is processed into the barrier member, or they may be formed after the barrier member 21 takes shape in a separate process. It is to be understood that one of ordinary skill in the art would be able to select the proper method to form the transverse vents and depressions without undue experimentation.

It is contemplated that the surface irregularities, improves the venting of the air bubble entrapped between the barrier member 21 and the container 10, which is generally known in the art to enhance the sealing performance of the barrier member 21 during the product loading process.

Numerous modifications and variations of the present disclosure are possible in light of the above disclosure. It is therefore to be understood that, within the scope of the appended claims, the invention may be practiced otherwise than as specifically described herein. While only certain embodiments have been set forth, alternatives and modifications will be apparent from the above description to those skilled in the art. These and other alternatives are considered equivalents and within the spirit and scope of this disclosure and the appended claims.

What is claimed is:

1. A slidable barrier member for use in a pressurized container, comprising:
a tubular side portion comprising a top end, a bottom end having a sealing portion conforming to the interior surface of the container, and a tubular sidewall extending between the top and bottom ends, the tubular side portion further having at least one surface irregularity to enable an effective product seal between the container and the side portion of the barrier member; and
a top portion closing the top end of the tubular sidewall.

2. The barrier member of claim 1, wherein the permeation resistance of the barrier member against aerosol propellants is greater than that of a piston substantially made of polymeric material.

3. The barrier member of claim 1, wherein the bottom end of the tubular side portion comprises a flange, the flange conforming to the interior surface of the container.

4. The barrier member of claim 1, wherein the barrier member is formed of a sheet metal.

5. The barrier member of claim 4, wherein the sheet metal is one of steel and aluminum.

6. The barrier member of claim 1, wherein the barrier member further includes at least one recess disposed on the exterior surface of the side portion to enhance the flexibility of the side portion.

7. The barrier member of claim 1, wherein the barrier member further comprises an anti-corrosive surface coating.

8. The barrier member of claim 1, wherein the surface irregularity is in a form of a contoured profile on the bottom edge of the barrier member.

9. The barrier member of claim 8, wherein the contoured profile is one of sinusoidal, castellated, and scalloped.

10. The barrier member of claim 8, wherein the bottom edge of the barrier member comprises at least one inward curl.

11. The barrier member of claim 1, wherein the surface irregularity is in the form of at least one transverse vent provided on the sidewall of the barrier member.

12. The barrier member of claim 1, wherein the surface irregularity is in the form of at least one transverse vent provided on the bottom end of the barrier member.

13. The barrier member of claim 1, wherein the surface irregularity is in the form of at least one depression provided on the bottom end of the barrier member.

14. A slidable barrier member for use in a pressurized container, comprising:
a tubular side portion having a closed top end and an open bottom end, the tubular side portion having a tubular sidewall and a flange radially protruding from the bottom of the sidewall and conforming to the interior surface of the container, the side portion further comprising at least one recess disposed on the exterior surface of the side portion to enhance the flexibility of the barrier member; and
a top portion closing the top end of the tubular side portion.

15. The barrier member of claim 14, wherein the barrier member is formed of a sheet metal.

16. The barrier member of claim 14, wherein the side portion of the barrier member is capable of conforming to irregularities of the interior surface of the container when the container is pressurized.

17. The barrier member of claim 14, wherein the bottom end of the barrier member includes a bottom edge having a contoured profile, the contoured profile being one of sinusoidal, castellated, and scalloped.

18. The barrier member of claim 14, wherein the bottom end of the barrier member includes a bottom edge comprising at least one inward curl.

19. The barrier member of claim 14, wherein the side portion of the barrier member comprises at least one transverse vent.

20. The barrier member of claim 14, wherein the at least one recess is vertical and extends substantially throughout the vertical length of the side portion.

21. The barrier member of claim 14, wherein the permeation resistance of the barrier member against aerosol propellants is greater than that of a piston substantially made of polymeric material.

22. A slidable barrier member for use in a pressurized container, comprising:
a tubular side portion having a closed top end, an open bottom end having a sealing portion conforming to the interior surface of the container, and a tubular sidewall extending between the top and bottom ends, the bottom end of the barrier member further comprising a bottom edge having at least one inward curl to reduce scratching of the interior surface of the pressurized container; and
a top portion closing the top end of the tubular side portion.

23. The barrier member of claim 22, wherein the permeation resistance of the barrier member against aerosol propellants is greater than that of a piston substantially made of polymeric material.

24. The barrier member of claim 22, wherein the barrier member is formed of a sheet metal.

25. The barrier member of claim 22, wherein the bottom edge of the flange has a contoured profile, the contoured profile being one of sinusoidal, castellated, and scalloped.

26. The barrier member of claim 22, wherein the side portion of the barrier member further comprises at least one transverse vent.

27. The barrier member of claim 22, wherein the bottom end of the barrier member further comprises at least one depression.

28. A slidable barrier member for use in a pressurized container, comprising:
a tubular side portion comprising a top end, a bottom end having a sealing portion conforming to the interior surface of the container, and a tubular sidewall extending between the top and bottom ends; and
a top portion closing the top end of the tubular sidewall,
the permeation resistance of the barrier member against carbon dioxide being less than 0.01 cm³·mm/(m²·day).

29. The barrier member of claim 28, wherein the barrier member is formed of a sheet metal.

30. The barrier member of claim 28, wherein the bottom end of the barrier member comprises a bottom edge having a contoured profile, the contoured profile being one of sinusoidal, castellated, and scalloped.

31. The barrier member of claim 28, wherein the side portion of the barrier member further comprises at least one transverse vent.

32. The barrier member of claim 28, wherein the exterior surface of the side portion further comprises at least one recess to enhance the flexibility of the side portion.

33. A slidable barrier member for use in a pressurized container, comprising:
a tubular side portion comprising a top end, a bottom end having a sealing portion conforming to the interior surface of the container, and a tubular sidewall extending between the top and bottom ends; and
a top portion closing the top end of the tubular sidewall,
the permeation resistance of the barrier member against nitrogen being less than 0.0015 cm³·mm/(m²·day)
